(19) United States
(12) Patent Application Publication
(10) Pub. No.: US 2010/0033985 A1
(43) Pub. Date: Feb. 11, 2010

(54) LED Luminescent Device and Vehicle Lamp Comprising the Device

(76) Inventors: Jih-Tao Hsu, Taipei City (TW); Chun-Ching Lai, Dali City (TW); Yu-Jen Chuang, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/189,233

(22) Filed: Aug. 11, 2008

(51) Int. Cl. B60Q 1/00; F21V 7/00

(52) U.S. Cl. 362/539; 362/308

(57) ABSTRACT

An LED luminescent device comprises an LED light source, a reflector, a light shade and a projecting lens. The LED light source comprises at least one LED element having a light-emitting surface emitting light. The reflector faces the light-emitting surface of the at least one LED element and has multiple reflection surfaces of different curvatures reflecting the light form the light-emitting surface of the at least one LED element. The light shade adjusts the light reflected by the reflector to provide a required light distribution pattern. The projecting lens projects the required light distribution pattern. Thus the device and a vehicle lamp comprising the device can prevent light energy from losing.

### BACKGROUND OF THE INVENTION

1. Field of Invention

The present invention relates to a luminescent device, and more particularly to an LED luminescent device and vehicle lamp comprising the device that can utilize light energy more efficiently.

2. Description of the Related Art

Because LEDs (light-emitted diodes) have characteristics of low power consumption, small size and long life span, they are applied more and more extensively to light sources, such as headlights, turn signal lamps or brake lamps for vehicles.

A conventional LED luminescent device for vehicle lamps comprises an LED light source, a reflector, a light shade and a light cover. The LED light source has a light-emitting surface that emits light toward an upper direction. The reflector is disposed above the light-emitting surface of the LED light source and reflects the light from the light-emitting surface toward a front direction. The light shade is disposed in front of the LED light source for providing a required light distribution pattern. The light cover is disposed in front of the light shade.

However, because the reflector of the conventional LED luminescent device has a reflection surface with single curvature, the reflector can only collect the light from the light-emitting surface toward the upper and front directions. For this reason, the light from the light-emitting surface toward a rear direction is hard to be collected by the reflector and is wasted. Additionally, the light of the reflection surface with single curvature cannot effectively converge on the position of the light shade so some of the light energy is lost and wasted.

To overcome the shortcomings, the present invention provides an LED luminescent device and vehicle lamp comprising the device to mitigate or obviate the aforementioned problems.

### SUMMARY OF THE INVENTION

The primary objective of the present invention is to provide an LED luminescent device and vehicle lamp comprising the device that can prevent the light from losing.

An LED luminescent device in accordance with the present invention comprises an LED light source, a reflector, a light shade and a projecting lens. The LED light source comprises at least one LED element and the at least one LED element has a light-emitting surface. The reflector faces the light-emitting surface of the at least one LED element and has multiple reflection surfaces with different curvatures reflecting the light from the light-emitting surface of the at least one LED element. The light shade adjusts the light reflected by the reflector to provide a required light distribution pattern. The projecting lens projects the required light distribution pattern.

Preferably, the at least one LED element comprises two trapezoidal LED elements that are arranged to form a rectangle.

Preferably, the projecting lens is an aspherical lens.

Preferably, each trapezoidal LED element is a high brightness LED of 200 lm.

Preferably, the reflection surfaces comprise a first reflection surface and a second reflection surface. The first reflection surface is disposed over the at least one LED element. The second reflection surface is disposed in rear of the at least one LED element.

Preferably, the second reflection surface is an afterglow composite reflection surface.

Preferably, the reflection surfaces are at a distance of more than 20 mm from the at least one LED element.

A vehicle lamp in accordance with the present invention comprises multiple foregoing LED luminescent devices.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an LED luminescent device in accordance with the present invention;

FIG. 2 is an exploded perspective view of the LED luminescent device in FIG. 1;

FIG. 3 is a cross-sectional side view of the LED luminescent device in FIG. 1;

FIG. 4 is an operational cross-sectional side view of the LED luminescent device in FIG. 1; and

FIG. 5 is a perspective view of a vehicle lamp in accordance with the present invention.

### DETAILED DESCRIPTION OF THE INVENTION

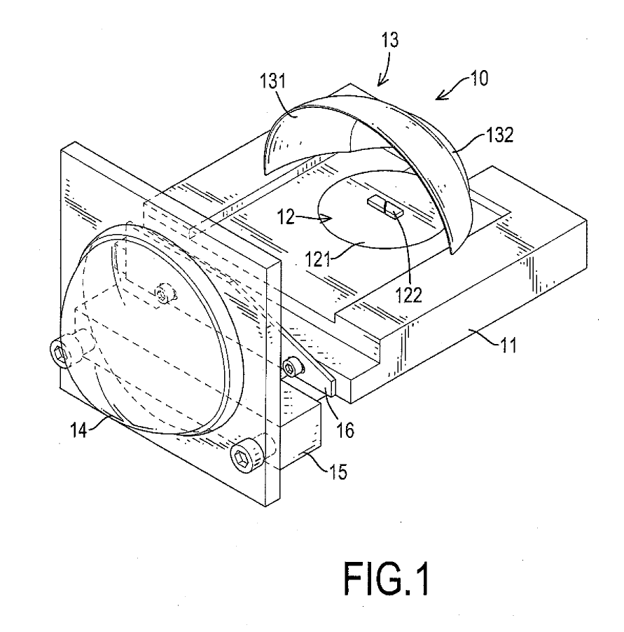

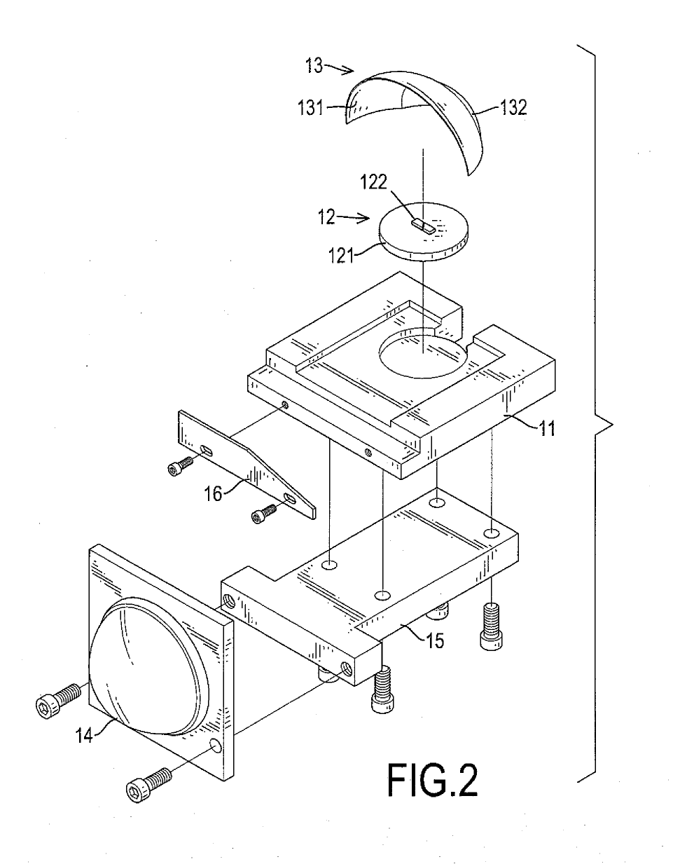

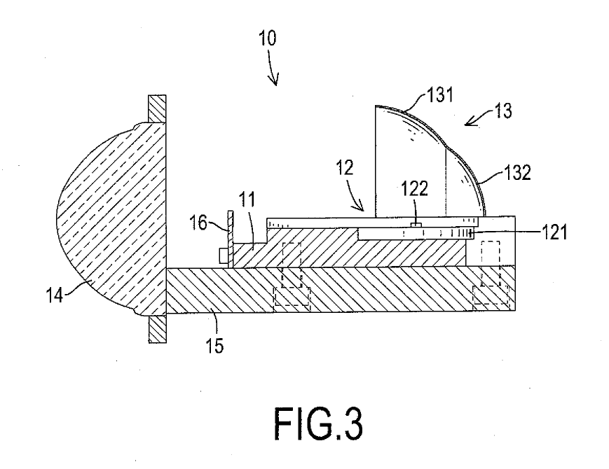

With reference to FIGS. 1 to 3, an LED luminescent device (10) in accordance with the present invention comprises a support (11), an LED light source (12), a reflector (13), a projecting lens (14), a base (15) and a light shade (16).

The support (11) is rectangular and has a top surface, a bottom surface, a front end and a cavity formed on the top surface.

The LED light source (12) is mounted on the cavity of the support (11) and may comprise a fastening pedestal (121) and at least one LED element (122). The fastening pedestal (121) is mounted in the cavity of the support (11). The at least one LED element (122) is mounted on the fastening pedestal (121) and has a light-emitting surface toward an upper direction. The at least one LED element (122) may comprise two trapezoidal LED elements arranged to form a rectangle. Each one of the at least one LED element (122) may be a high brightness LED of 200 lm (lumen). Thus the LED light source (12) may provide a light pattern and brightness distribution that meet a criterion of a vehicle headlight.

The reflector (13) is disposed above the at least one LED element (122), faces the light-emitting surface of each one of the at least one LED element (122) and has a gap in front of the at least one LED element (122). The reflector (13) has multiple reflection surfaces that may comprise a first reflection surface (131) and a second reflection surface (132) and the reflection surfaces (131)(132) may be at a distance of more than 20 mm from the at least one LED element (122). Furthermore, the curvature of the first reflection surface (131) differs from the second reflection surface (132). The first reflection surface (131) is disposed over the at least one LED element (122) to reflect the light from the at least one LED element (122) to a front direction. The second reflection surface (132) is connected to the first reflection surface (131), is disposed in rear of the at least one LED element (122) to reflect the light from the at least one LED element (122) to the front direction. Thus the second reflection surface (132) can collect and reflect the light originally lost and serve as an afterglow composite reflection surface. Additionally, the reflection surfaces (131)(132) of different curvatures can reflect the light from the at least one LED element (122) to a predominated position.

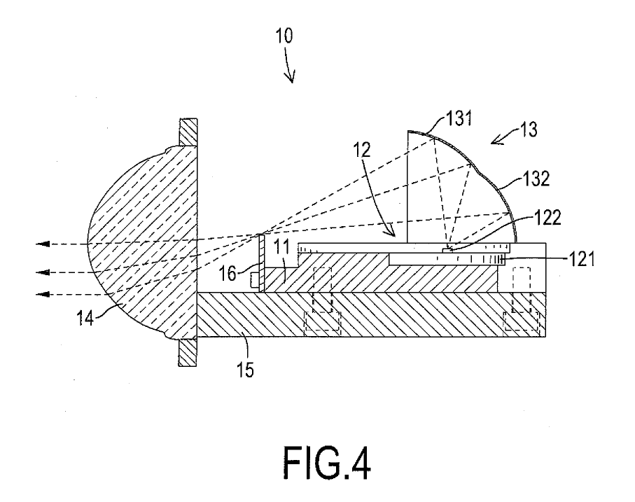

With reference to FIG. 4, the light shade (16) is disposed in front of the LED light source (12) and has a top edge higher than the top surface of the support (11) so as to adjust the light reflected by the reflector (13) to provide a required light distribution pattern.

The projecting lens (14) is disposed in front of the reflector (13) and corresponds to the gap of the reflector (13) and projects the required light distribution pattern. The projecting lens (12) is spaced from the reflector (13) and may be an aspherical lens.

The base (15) is mounted on the bottom surface of the support (11) and has a front end protruding from the front end of the support (11) and connected to the projecting lens (14).

Because the reflector (13) has the second reflection surface (132) in rear of the at least one LED element (122) to collect the originally lost light toward a rear direction, the originally lost light is reflected by the second reflection surface (132) to the front direction. The originally lost light converges near the top edge of the light shade (16) with the light reflected by the first reflection surface (131). Thus the light energy can be utilized efficiently without wasting.

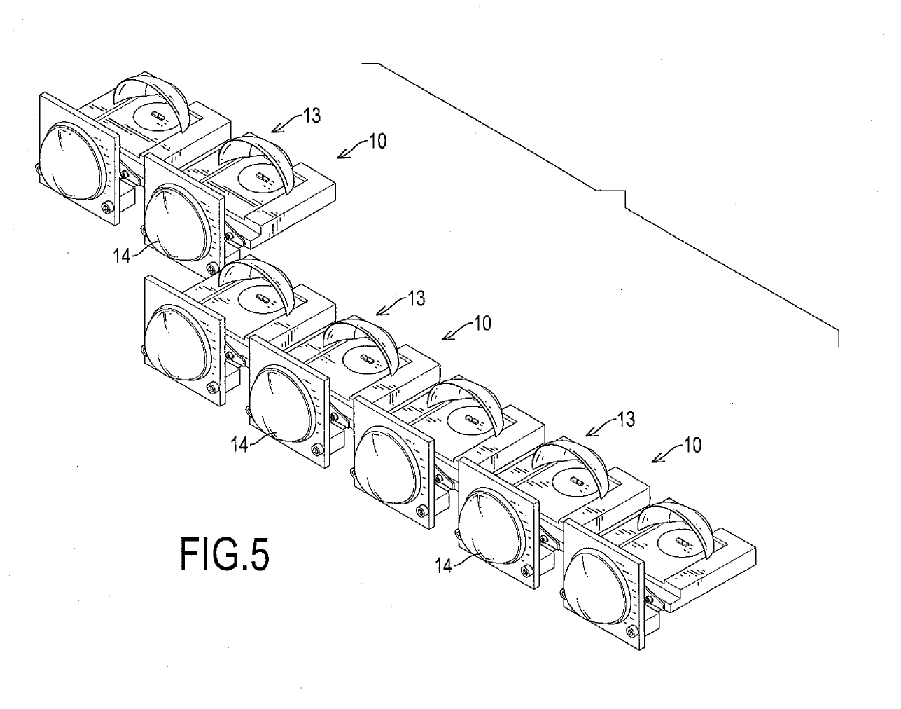

With reference to FIG. 5, a vehicle lamp in accordance with the present invention comprises multiple LED luminescent devices (10) as described. Thus the vehicle lamp has a large scale and may serve as a head lamp, turn signal lamp or other vehicle lamps.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An LED luminescent device comprising
an LED light source comprising at least one LED element having a light-emitting surface emitting light;
a reflector facing the light-emitting surface of the at least one LED element and having multiple reflection surfaces of different curvatures reflecting the light form the light-emitting surface of the at least one LED element;
a light shade adjusting the light reflected by the reflector to provide a required light distribution pattern; and
a projecting lens projecting the required light distribution pattern.

2. The LED luminescent device as claimed in claim 1, wherein the at least one LED element comprises two trapezoidal LED elements being arranged to form a rectangle.

3. The LED luminescent device as claimed in claim 2, wherein the projecting lens is an aspherical lens.

4. The LED luminescent device as claimed in claim 3, wherein each trapezoidal LED element is a high brightness LED of 200 lm.

5. The LED luminescent device as claimed in claim 2, wherein each trapezoidal LED element is a high brightness LED of 200 lm.

6. The LED luminescent device as claimed in claim 1, wherein the reflection surfaces comprise
a first reflection surface being disposed over the at least one LED element; and
a second reflection surface being disposed in rear of the at least one LED element.

7. The LED luminescent device as claimed in claim 6, wherein the second reflection surface is an afterglow composite reflection surface.

8. The LED luminescent device as claimed in claim 1, wherein the reflection surfaces are at a distance of more than 20 mm from the at least one LED element.

9. A vehicle lamp comprising multiple LED luminescent devices and each LED luminescent device comprising
an LED light source comprising at least one LED element having a light-emitting surface emitting light;
a reflector facing the light-emitting surface of the at least one LED element and having multiple reflection surfaces of different curvatures reflecting the light form the light-emitting surface of the at least one LED element;
a light shade adjusting the light reflected by the reflector to provide a required light distribution pattern; and
a projecting lens projecting the required light distribution pattern.

10. The vehicle lamp as claimed in claim 9, wherein the at least one LED element comprises two trapezoidal LED elements being arranged to form a rectangle.

11. The vehicle lamp as claimed in claim 10, wherein the projecting lens is an aspherical lens.

12. The vehicle lamp as claimed in claim 11, wherein each trapezoidal LED element is a high brightness LED of 200 lm.

13. The vehicle lamp as claimed in claim 10, wherein each trapezoidal LED element is a high brightness LED of 200 lm.

14. The vehicle lamp as claimed in claim 13, wherein the reflection surfaces comprise
a first reflection surface being disposed over the at least one LED element; and
a second reflection surface being disposed in rear of the at least one LED element.

15. The vehicle lamp as claimed in claim 9, wherein the second reflection surface is an afterglow composite reflection surface.

16. The vehicle lamp as claimed in claim 9, wherein the reflection surfaces are at a distance of more than 20 mm from the at least one LED element.
